(19) United States
(12) Patent Application Publication
(10) Pub. No.: US 2022/0075814 A1
(43) Pub. Date: Mar. 10, 2022

(54) DATABASE CREATION AND MANAGEMENT OF MULTIPLE DIGITAL INTERACTIONS

(71) Applicant: Radix Metasystems, Inc., Aurora, CO (US)

(72) Inventors: Peter R. Molina, Lakewood, CO (US); Todd A. Kester, Aurora, CO (US); Alan R.A. Hamor, Parker, CO (US); Rene Jonathan Ernst, Aurora, CO (US)

(21) Appl. No.: 17/379,624

(22) Filed: Jul. 19, 2021

Related U.S. Application Data
(60) Provisional application No. 63/076,313, filed on Sep. 9, 2020.

(51) Int. Cl. G06F 16/48; G06F 16/438; G06F 16/41

(52) U.S. Cl. CPC G06F 16/489; G06F 16/41; G06F 16/438

(57) ABSTRACT

Systems and methods are disclosed for creating a digital interaction database. A first digital interaction dataset can be received. A second input file may be received. The first and second input files may include a plurality of digital records of interaction between individuals recorded by a different providers. In some embodiments, the second provider being different and distinct from the first provider. A digital interaction database may be created from digital records in both the first digital interaction dataset and the second input file. In some embodiments, each digital interaction within the digital interaction database comprises at least a date of the digital interaction, a time of the digital interaction, an identifier associated with the sender of the digital interaction, and an identifier associated with the receiver of the digital interaction.

### BACKGROUND

Modern criminal investigation techniques often use cell phone data and/or other digital data to track a person of interest's activity and/or to determine whom a person of interest has interacted. Digital interaction records can come from a variety of sources, have a different data structures, include different data, etc.

### SUMMARY

Systems and methods are disclosed for creating a digital interaction database. A first digital interaction dataset can be received. A second input file may be received. The first and second input files may include a plurality of digital records of interaction between individuals recorded by different providers. In some embodiments, the second provider being different and distinct from the first provider. A digital interaction database may be created from digital records in both the first digital interaction dataset and the second input file. In some embodiments, each digital interaction within the digital interaction database comprises at least a date of the digital interaction, a time of the digital interaction, an identifier associated with the sender of the digital interaction, and an identifier associated with the receiver of the digital interaction.

In some embodiments, each digital interaction within the digital interaction database comprises at least one of the following: a location of the sender of the digital interaction, a location of the receiver of the digital interaction, a cell tower location associated with a sender of the digital interaction, a cell tower location associated with a receiver of the digital interaction, digital interaction content, photos, text, and a duration of the digital interaction.

In some embodiments, the method may also include receiving a cell phone tower dataset that correlates a cell phone tower location with a cell phone tower identifier and wherein the second input file comprises cell phone tower identifiers associated with at least some of the second plurality of digital records.

In some embodiments, the method may also include identifying a first individual associated with a first digital record in the first digital interaction dataset that corresponds with a second digital record in the second input file.

In some embodiments, the first digital interaction dataset is organized differently than the second input file. In some embodiments, the first digital interaction dataset includes data that is not included in the second input file. In some embodiments, the first provider or the second provider comprises a cell phone carrier. In some embodiments, the first provider or the second provider comprises a social media company.

In some embodiments, the first digital interaction dataset or the second input file comprises cell phone records. In some embodiments, the first digital interaction dataset or the second input file comprises social media records.

In some embodiments, the first digital interaction dataset or the second input file includes a plurality of records, each of the plurality or records including one or more of the following: an interaction date, an interaction time, a sender name, a sender ID, a sender phone number, a sender email address, a sender username, a receiver name, a receiver ID, a receiver phone number, a receiver email address, a receiver username, a GPS location of the sender, a GPS location of the receiver, a tower location of the sender, a tower location of the receiver, a tower identifier of the sender, a tower identifier of the receiver, bank account of sender, bank account of receiver, amount of money sent or received, and interaction content.

Some embodiments include a method that includes selecting a first digital interaction from a first digital interaction dataset, determining a first digital interaction identifier from the first digital interaction, and finding a second digital interaction identifier associated with a second digital interaction of a second input file that matches the first digital interaction identifier. In some embodiments, the first digital interaction dataset includes a first plurality of digital records of interaction between individuals recorded by a first provider and the first digital interaction identifier identifies a party associated with the first digital interaction.

In some embodiments, the method may also include selecting a third digital interaction from the first digital interaction dataset; determining a third digital interaction identifier from the third digital interaction, the third digital interaction identifier identifies a party associated with the first digital interaction; and finding a fourth digital interaction identifier within the second digital interaction of a second input file that matches the third digital interaction identifier.

In some embodiments, the method may also include finding a third digital interaction identifier associated with a third digital interaction of a third digital interaction dataset that matches the first digital interaction identifier.

In some embodiments, the method may also include searching a third digital interaction dataset for one or more digital interactions that include a third digital interaction identifier that matches the first digital interaction identifier.

In some embodiments, the first digital interaction identifier comprises a phone number. In some embodiments, the first digital interaction identifier comprises an email address. In some embodiments, the first digital interaction identifier comprises a username.

In some embodiments, the method may also include linking the first digital interaction with the second digital interaction.

In some embodiments, the first digital interaction dataset and the second input file are different digital interaction datasets. In some embodiments, the first digital interaction dataset and the second input file comprise datasets of telephone histories from two different telephone carriers. In some embodiments, the first digital interaction dataset and the second input file comprise datasets of social media histories. In some embodiments, the first digital interaction identifier is an incoming phone number and the second digital interaction identifier is an outgoing phone number. The various embodiments described in the summary and this document are provided not to limit or define the disclosure or the scope of the claims.

### BRIEF DESCRIPTION OF THE FIGURES

FIG. 1 is a block diagram of a digital interaction database according to some embodiments.

FIG. 2 is a block diagram of a process for creating a digital interaction database according to some embodiments.

FIG. 3 is a flowchart of a process for creating a digital interaction database according to some embodiments.

FIG. 4 is a flowchart of a process for linking digital interactions according to some embodiments.

FIG. 5 is a block diagram of a computational system that can be used with or to perform some embodiments described in this document.

FIG. 6 illustrates an example cloud computing system according to some embodiments.

### DETAILED DESCRIPTION

A digital interaction data base is disclosed that includes a plurality of digital interaction datasets from different digital interaction providers. A digital interaction, for example, may include a cell phone record, a text message record, an email record, a social media record, a messenger record, a WhatsApp record, a snapchat record, a financial transaction record, a GPS tracker, mobile phone GPS data, etc.

A digital interaction dataset, for example, may be used to interactively display digital interactions of individuals in an investigation. These digital interactions may, for example, provide information about how often and how long individuals interact digitally. As another example, these digital interactions may provide information about the location of an individual during a digital interaction.

Some embodiments disclose creating a digital interaction database. And some embodiments disclose linking associated digital interactions across different digital interaction datasets.

A digital interaction dataset may include a history of digital interactions between an individual associated with the digital interaction and a plurality of other individuals.

A digital interaction, for example, may include one or more of the following fields: an interaction date, an interaction time, an interaction duration, a sender name, a sender ID (e.g., phone number, email address, handle, username, account number, social media id, advertising id, etc.), a receiver name, a receiver ID (e.g., phone number, email address, handle, username, account number, social media id, advertising id, etc.), a GPS location of the sender, a GPS location of the receiver, a tower location of the sender, a tower location of the receiver, a tower identifier of the sender, a tower identifier of the receiver, IP-address of the sender, an IP address of the receiver, bank account number of the resender, a bank account number of the receiver, interaction content, amount of money sent or received, social media history, social media posts, social media messages, social media contacts, calendar data, internet search history, cookie data, webpage interaction data, phone app usage history, financial documents, computer forensic data, computer, tablet, and/or phone usage data, etc.

For example, a digital interaction from a mobile phone using a first carrier may include the following: latitude of the tower, longitude of the tower, the time of the interaction, the outgoing phone number, the called phone number, and the direction of the call.

As another example, a digital interaction from a mobile phone using a second carrier may include the time of the interaction, a cell tower identifier, the outgoing phone number, the called phone number, and the direction of the call. In addition, the second carrier may include a second record or dataset that correlates the cell tower identifier with a latitude of the tower and a longitude of the tower.

A digital interaction dataset, for example, may include a plurality of digital records of digital interaction between individuals. These digital interactions may include any type of digital interaction.

The type of data in a digital interaction dataset, for example, may vary depending on the digital interaction provider of the digital interaction dataset. For example, a cell phone digital interaction dataset may include data that is different than a social media digital interaction dataset or an ankle bracelet digital interaction dataset.

The format of the digital interaction dataset, for example, may vary depending on the digital interaction provider of the digital interaction dataset. For example, a digital interaction dataset may be formatted as a csv file, an excel file, a text file, an XML file, an HTML file, a zip archive containing multiple files including media such as images, video, etc.

Two different digital interaction datasets, for example, may include a plurality of rows of data comprising different digital records of interactions yet have columns with different data types. In some embodiments, two different digital interaction datasets may include a plurality of rows of data comprising different digital records of interactions organized with different columns of data for each digital record of an interaction.

Each digital interaction dataset, for example, may be associated with an individual. In some embodiments, two different digital interaction datasets may be associated with two different individuals.

For example, a GPS tracking digital interaction dataset (e.g., from a GPS tracking ankle bracelet) may include one or more of the following columns of data: agency name, officer name, name of the monitored person, event name, event time (possibly more than one time zones), location, GPS valid data, GPS High confidence data, and/or GPS confidence data, etc.

As another example, a digital interaction dataset may include one or more of the following columns of data: Calling-MDN, Called-MDN, Billing-MDN, Destination-Number, Dialed-Number, Date, Time, Timezone, Timezone-type, Duration, Direction, MSC-ID, LAC-CI, LAC-Dec, CI-Dec, Enode-Dec, TRoute, Ans-Status, Comp-Code, Service-Codes, first-Latitude, first-Longitude, first-sectorid, first-azimuth, first-address, first-city, first-state, first-zip, last-Latitude, last-Longitude, last-sectorid, last-azimuth, last-address, last-city, last-state, last-zip, MSC-name, Call-Type, Service-Center, IMSI, Imei, Disconnecting-Party, Srvcc-Indicator, and/or Sms-Result, etc.

As another example, a digital interaction dataset may include one or more of the following columns of data: phone number, Electronic Serial Number (ESN), call start time, duration (e.g., in seconds), vendor, call type, latitude, longitude, distance (e.g., in miles), sector, cascade id, or BAN, etc. In some embodiments, the latitude and/or the longitude may comprise the latitude and/or the longitude of the device making the digital interaction or the cell phone tower communicating with the device.

As another example, a digital interaction dataset may include one or more of the following columns of data: calling number, called number, dialed digits, call direction (e.g., outbound, inbound, routed, etc.), start date, end date, duration (sec), network element identifier (neid), phone switch (repoll), 1st cell (the first cell site that was used during a call), or last cell (the last cell site that was used during a call), etc.

As another example, a digital interaction dataset may include one or more of the following columns of data: item, connection date & time (e.g., UTC), seizure time (e.g., the time it takes for the call to connect to the network), elapsed time, originating number, terminating number, IMEI, international mobile subscriber identity (IMSI), call type (CT) (Mobile Originating (MO), Mobile Terminating (MT), Service Originating (SO), Service Terminating (ST), etc.), feature, dialed, for example, forwarded, translated, orig_orig, make of the handset, model of the handset, or cell location, etc.

A digital interaction provider, for example, may include a mobile phone carrier (e.g., Verizon, AT&T, T-Mobile, Sprint, etc.), a social media company (e.g., Facebook, LinkedIn, SnapChat, Instagram, TikTok, etc.), a messaging company (e.g., messenger, WhatsApp, WeChat, iMessage, Messages, etc.), a mobile phone provider (e.g., Android, Apple, etc.), a map company (e.g., Google Maps, Apple Maps, etc.), an advertising id tracking company (e.g., Babel X), etc.

A person of interest record, for example, may include one or more digital interaction datasets. In some embodiments, each person of interest may be associated with data from one digital interaction provider or many different digital interaction providers.

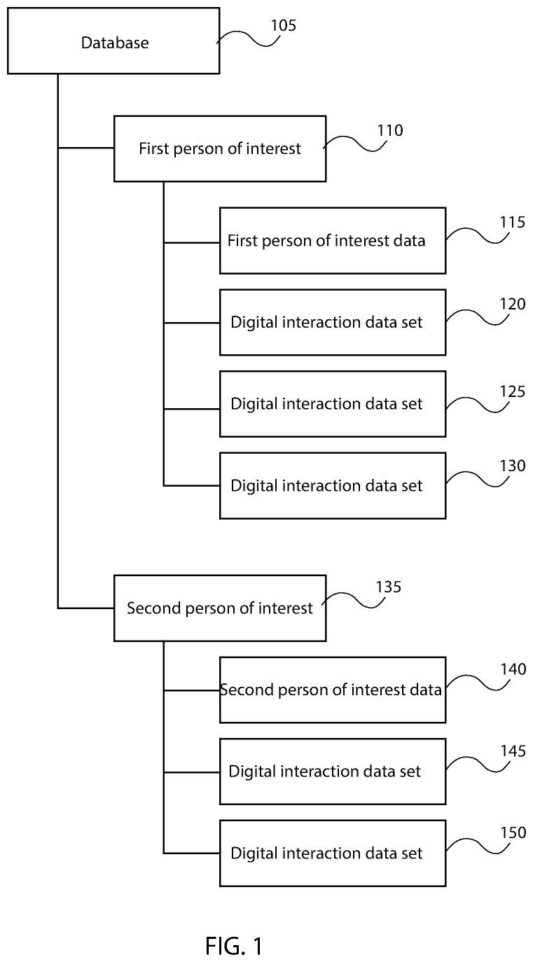

FIG. 1 is a block diagram of a digital interaction database 105 according to some embodiments. The database 105 may include the digital interactions for one person of interest or a plurality of persons of interest. A person of interest may include person of interest in an investigation such as, for example, suspects, victims, witness, defendant, associate, etc. In this specific example, the database 105 includes two persons of interest: the first person of interest 610 and the second person of interest 135.

In this example, the first person of interest 610, may include first person of interest data 115. The first person of interest data 115 may include data about the first person of interest such as, for example, name, age, photograph(s), phone number, email address, address, social media ID, license plate, advertising id, other identifiers, etc.

In this example, the first person of interest 610, may include the first digital interaction dataset 120, the first digital interaction dataset 125, and the first digital interaction dataset 130 (collectively, the first person of interest datasets). Other additional digital interaction datasets may also be uploaded and included with the first person of interest. The first person of interest datasets may include any digital interaction dataset described in this document or other digital interaction datasets.

For example, the first digital interaction dataset 120 may include a history of telephone records of the first person of interest to and from various other individuals. The first digital interaction dataset 125 may include a history of text messages to and from the first person of interest to and from various other individuals. The first digital interaction dataset 130 may include a history of digital interactions of the first person (e.g., posts, comments, images, videos, etc.) of interest on a social media platform.

In this example, the second person of interest 135, may include the second person of interest data 140. The second person of interest data 140 may include data about the first person of interest such as, for example, name, age, photograph(s), phone number, email address, address, social media ID, license plate, advertising id, other identifiers, etc.

In this example, the second person of interest 135, may include the second digital interaction dataset 145 and the second digital interaction dataset 150 (collectively, the second person of interest datasets). Other additional digital interaction datasets may also be uploaded and included with the second person of interest. The second person of interest datasets may include any digital interaction dataset described in this document or other digital interaction datasets.

For example, the second digital interaction dataset 120 may include a history of telephone records of the first person of interest to and from various other individuals. The second digital interaction dataset 125 may include a history of text messages to and from the first person of interest to and from various other individuals. The second digital interaction dataset 130 may include a history of digital interactions of the first person (e.g., posts, comments, images, videos, etc.) of interest on a social media platform.

A first digital interaction in one of the first person of interest datasets and a second digital interaction in one of the second person of interest datasets, for example, can be linked such as, for example, in the dataset directory 240. For example, the first digital interaction may include a history of phone records between the first person of interest and a number of other people. If one of these other people includes the second person of interest, the digital interaction (e.g., the phone call between the two) in the first person of interest datasets and the digital interaction in the second person of interest datasets can be linked. As another example, the first digital interaction may include a history of messages (e.g., text, SMS, messenger, WhatsApp, WeChat, etc.) between the first person of interest and a number of other people. If one of these other people includes the second person of interest, the digital interaction (e.g., the message between the two) in the first person of interest datasets and the digital interaction in the second person of interest datasets can be linked.

Two digital interactions can be linked in a number of different ways. As one example, the first person of interest data 115 may include a first phone number. An algorithm executing on a process (e.g., in the cloud) may search all or most digital interactions within all digital interaction datasets (e.g., other than the person of interest associated with the first phone number) for phone calls to or from the first phone number. This can be done for each phone number, messenger ID, email address, etc. associated with the first person of interest and or stored in the first person of interest data 115. This may also be done for each person of interest.

As another example, each digital interaction associated with one person of interest may be compared with each digital interaction associated with another person of interest. If a correlation is found, a link between the two digital interactions may be created. For example, an algorithm may select a first digital interaction from a first digital interaction dataset. An identifier (e.g., phone number, email address, Id, username, etc.) associated with the first digital interaction may be extracted. This identifier may then be used to search all or most digital interactions within all digital interaction datasets for the identifier. If a match is found between the identifier and another digital interaction, then a link between the digital interactions can be made.

A link between digital interactions, for example, shows that a digital interaction occurred between the two persons of interest. This digital interaction may also be associated with duration data, the direction of the digital interaction, the location of the sender or the receiver, and/or content of the digital interaction, etc.

A cloud computing system may be used to receive, store, and/or process the digital interaction datasets. For example, a web portal may be created that allows a user to upload one or more input files. A webpage may be provided that allows the user to interact and/or view data with the digital interaction dataset before, during and after processing the data in the digital interaction dataset.

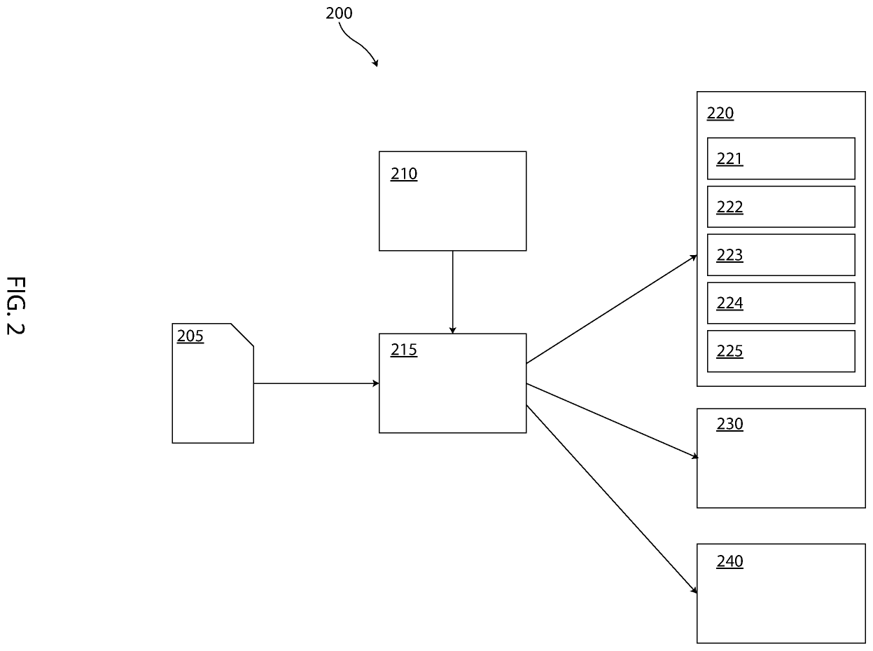

FIG. 2 is a block diagram of a processing structure 200 for creating a digital interaction database according to some embodiments. The processing structure 200 may include all the block shown in the figure, a portion of the blocks shown in the figure, and/or may include any number of additional blocks

One or more input files 205 can be processed with processor 215 using mapping definition 210 into one or more digital interaction datasets 230 and/or one or more dataset descriptors 220.

The processor 215 may include any or all elements of the computational system 500. The processor 215 may be a cloud based processor with one or more dedicated and/or remote processors. The processor 215 may operate on one or more digital interaction datasets.

The processor 215 may include a plurality of processors. Each processor 215 of the plurality of processors may process a specific type of input file 205. For example, a first processor may process Verizon phone records. A second processor, for example, may process Facebook records. A third process, for example, may process AT&T phone records. A fourth processor, for example, may process messaging records. Various other specific processors may also be used.

The processor 215 may process the input file 205 based on a mapping definition 210. The mapping definition 210 may define transformations for each field in a specific input file 205 to one or more digital interaction datasets 230. The mapping definition 210 may define how the processor 215 maps data from one or more input file 205 to data in one or more digital interaction datasets 230.

The processor 215, for example, may create a single digital interaction dataset 230 from a single input file 205 using the mapping definition 210.

The processor 215, for example, may create a plurality of digital interaction datasets 230 from a single input file 205 using the mapping definition 210. For example, an input file 205 from a wireless carrier such as, for example, AT&T, may include phone data, text data, and Internet data access records in a single input file 205. Each of these data may be mapped into one or more digital interaction datasets 230. As another example, a Google input file 205 may include email data, photo data, GPS data, search history data, IP data list, device access data, etc. Each of these may be mapped into one or more digital interaction datasets 230.

The processor 215, for example, may create a single digital interaction datasets 230 from a plurality of input files 205 using the mapping definition 210. For example, an input file 205 from a wireless carrier such as, for example, Verizon, may require a phone input file 205, a text input file 205, and/or a cell tower input file 205. Two or more of these input file 205 may be mapped into a single digital interaction datasets 230.

Each digital interaction datasets 230, for example, may include a JSON File (or a JSON Lines file or an XML file or the like) where each row includes a data item transformed (or mapped) from the input file 205 and/or described by the dataset descriptor 220. In some embodiments, each data item may include a JSON object composed of key/value pair data. A value may be complex such as a location feature or a simple value such as a string, number, date, etc. A key/value pair, for example, may include the following data: data source, data type, provider, date produced, number or account of interest, date of production, date of processing, etc.

The processor 215, for example, may produce a digital interaction dataset descriptor 220. In some embodiments, the dataset descriptor 220 may be stored in a cloud database. The dataset descriptor 220, for example, may describe various components of a digital interaction dataset. The dataset descriptor 220, for example, may include dataset metadata 221, dataset metadata key info 222, data item key info 223, data item key characterization 224, and/or data item key connectors 225.

The dataset metadata 221 may include information about the digital interaction datasets 230 such as, for example, specifics for each key/value pair in the digital interaction dataset 230, the type of data, account number, subscriber phone number, a social media id, an account number, email address, name, what processor was used, phone number(s), dates, the source of an associated digital interaction datasets 230, the date the data was uploaded, whether the data is a “special” type, the connections between fields that describe interactions, etc. As another example, the dataset descriptor 220 may include specific meta-data derived from the input file 205 such as the, etc.

The dataset metadata key info 222, for example, may describe the type of information contained in each key/value field for the digital interaction dataset. For example, if the data is considered an important type, a category can be set that allows the field to be used generically. In some embodiments, dataset metadata key info 222 may describe the columns of the digital interaction datasets 230. The dataset metadata key info 222, for example, may include information about what the keys in the Data Set Meta Data mean.

The data item key info 223, for example, may describe the data for use and display for each key/value in the digital interaction dataset. The data item key info 223 may also identify the special usable types for more generic use by the tools such as, for example, a phone number, email address, social media id, account number, location information, etc. The data item key info 223, for example, describes the fields in the data item. As another example, the data item key info 223, may identify whether the data a special type of data. As another example, the data item key info 223, may include a title for columns in a list tool, the source column name and/or the units for each column.

The data item key characterization 224, for example, may include statistics about a digital interaction dataset 230. For example, the data item key characterization 224 may include statistics or enumeration for each column, the type of data (e.g., strings, integers, dates, phone numbers, etc.), ranges, etc., etc.

The data item key connectors 225, for example, may define connections between datasets and/or interactions between two type of fields. This may include, for example, to-from relationships such as, between two callers (e.g., caller number and called number), between senders and receivers of messages or emails (e.g., message sender and message receiver), etc. In some embodiments the data item key connectors 225 may label the type of interaction such as, for example, “CALL”, “MESSAGE”, “COMMENT”, “MONEY” etc.

The processor 215, for example, may also update a dataset directory 240. The processor 215 may extract directory information associated with each digital interaction datasets 230. The dataset directory 240 may include a list of contacts from an email archive, friends from a social media file (e.g., Facebook file), or phone numbers from source files, etc. that can be used to associate the identifier to a specific individual (or alias). A single dataset directory 240 may include directory information from a plurality of digital interaction datasets 230.

For example, an AT&T input file 205 may include calls, text messages, and data access records (e.g., internet browsing) that can be mapped by the processor 215 into three separate digital interaction datasets 230 and dataset descriptors 220.

As another example, a Verizon (or Sprint) input file 205 may include multiple data files that can be mapped into one or more digital interaction datasets 230.

As another example, a Facebook input file 205 may include one or more files that include messages, wall posts, status updates, pictures, IP History, etc. that may be mapped into one or more digital interaction datasets 230 and/or one or more dataset descriptors 220.

As another example, a Google input file 205 may include one or more files that include messages (with or without message content), contacts, emails, photos, GPS data, search history data, IP data, device access list data, etc. that may be mapped into one or more digital interaction datasets 230 and/or one or more dataset descriptors 220.

As another example, an Apple input file 205 may include one or more files that include email, imessages (with or without content), photos, photos, GPS data, search history data, IP data, device access list data, contacts, etc. that may be mapped into one or more digital interaction datasets 230 and/or one or more dataset descriptors 220.

As another example, a phone scrape file (e.g., from Cellbrite) may include one or more files that include app data, location data, email data, text data (with or without content), phone data, IP data, device access list data, contacts, that may be mapped into one or more digital interaction datasets 230 and/or one or more dataset descriptors 220.

As another example, an advertising aggregator input file 205 may include ID tracking data with GPS data that may be mapped into one or more digital interaction datasets 230 and/or one or more dataset descriptors 220.

As another example, a GPS tracker (e.g., ankle, car, etc.) may include a list of GPS data associated with a date and time that may be mapped into one or more digital interaction datasets 230 and one or more dataset descriptors 220.

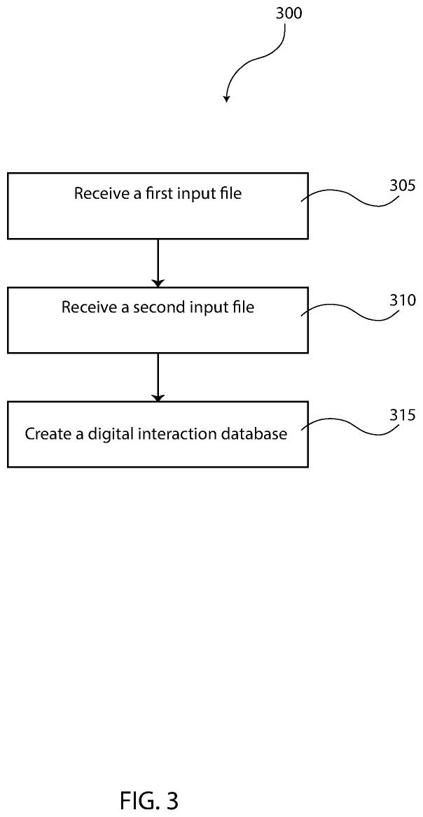

FIG. 3 is a flowchart of a process 300 for creating a digital interaction database (e.g., dataset descriptors 220 and/or a digital interaction datasets 230 and/or dataset directory 240) according to some embodiments. In some embodiments, the blocks in the process 300 may occur in any order. In some embodiments, any number of additional blocks may be included in the process 300

At block 305 a first input file (e.g., input file 205) may be received. For example, the first input file may be uploaded or otherwise transmitted to one or more cloud storage locations. As another example, the first input file may be accessed from a digital storage location and access by a local processor or cloud processor. The first input file may include data from a first provider. The first input file, for example, may include one or more input files. The first input file, for example, may be mapped by processor 215 into a one or more digital interaction datasets 230.

At block 310 a second input file may be received. For example, the second input file may be uploaded or otherwise transmitted to one or more cloud storage locations. As another example, the second input file may be accessed from a digital storage location and access by a local processor. The second input file may include data from a second provider or the first provider. The second input file, for example, may be mapped by processor 215 into a one or more digital interaction datasets 230.

The first input file and the second input file, for example, may originally be formatted differently, have different values, include different data, have different data structures, etc.

At block 315 a digital interaction database can be created from the digital records in both the first input file and the second input file. For example, the digital interaction database may include one or more digital interaction datasets 230 and/or the dataset directory 240. As another example, the digital interaction database may include the dataset descriptors 220.

One or more digital interactions within the digital interaction database may include a number of data items. For example, these data items may include a date of the digital interaction, a time of the digital interaction, an identifier associated with the sender of the digital interaction, and/or an identifier associated with the receiver(s) of the digital interaction, the content of the interaction, the duration of the interaction, etc. These digital interactions may be linked in the dataset directory 240.

The digital interaction database, for example, can include a third digital interaction dataset, a fourth digital interaction dataset, a fifth digital interaction dataset, etc. The digital interactions in the digital interaction database may include interactions between two or more individuals from the various digital interaction datasets.

The process 300, for example, may also receive a cell phone tower dataset that correlates a cell phone tower location with a cell phone tower identifier. In some embodiments, one or more of the digital interaction datasets may include cell phone tower identifiers associated with at least some of the second plurality of digital records.

For example, the process 300 may also include identifying a first individual associated with a first digital record in the first digital interaction dataset that corresponds with a second digital record in the second digital interaction dataset.

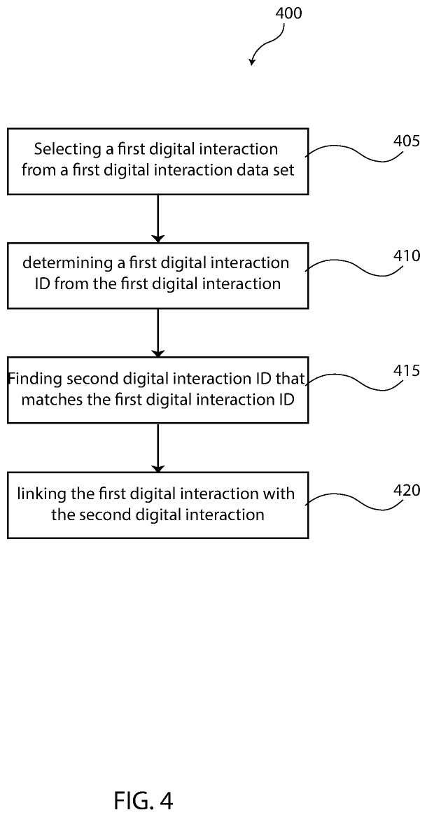

FIG. 4 is a flowchart of a process 400 for linking digital interactions according to some embodiments. In some embodiments, the blocks in the process 400 may occur in any order. In some embodiments, any number of additional blocks may be included in the process 400.

At block 405 a first digital interaction can be selected from a first digital interaction dataset. Any digital interaction from within the first digital interaction dataset can be selected.

At block 410 a first digital interaction identifier may be selected from the first digital interaction dataset. The first digital interaction identifier can identify a party associated with the first digital interaction. In some embodiments, the type of dataset may dictate the first digital interaction identifier. For example, if the first digital interaction dataset comprises a history of telephone records, then the first digital interaction identifier may include a phone number. If the first digital interaction dataset comprises a history of social member interactions, for example, then the first digital interaction identifier may include a social media username. If the first digital interaction dataset comprises a history of email records, then the first digital interaction identifier may include an email address.

At block 415 the second digital interaction dataset can be searched for a second digital interaction identifier associated with a second digital interaction that matches the first digital interaction identifier.

For example, if the first digital interaction identifier is the phone number 555-555-5555 in the first digital interaction dataset, then the second digital interaction dataset can be searched for the phone number 555-555-5555. For example, the first digital interaction identifier may include a sending phone number from a first individual's phone, and the second digital interaction identifier may include a receiving phone number. As another example, the first digital interaction identifier may include a receiving phone number from a first individual's phone, and the second digital interaction identifier may include a sending phone number.

The process 420, for example, may also include linking the first digital interaction with the second digital interaction with the database such as, for example, in the dataset directory 240.

The process 420, for example, may also include identifying a third digital interaction identifier may be selected from the first digital interaction dataset. The third digital interaction identifier can identify a party associated with the third digital interaction of the first individual. A third digital interaction can be found from the first digital interaction dataset. Then a third digital interaction identifier can be determined from the third digital interaction. In some embodiments, a fourth digital interaction identifier can be found within the second digital interaction of a second digital interaction dataset that matches the third digital interaction identifier.

The process 420, for example, may also include finding a third digital interaction identifier associated with a third digital interaction of a third digital interaction dataset that matches the first digital interaction identifier.

The process 420, for example, may also include searching a third digital interaction dataset for one or more digital interactions that include a third digital interaction identifier that matches the first digital interaction identifier.

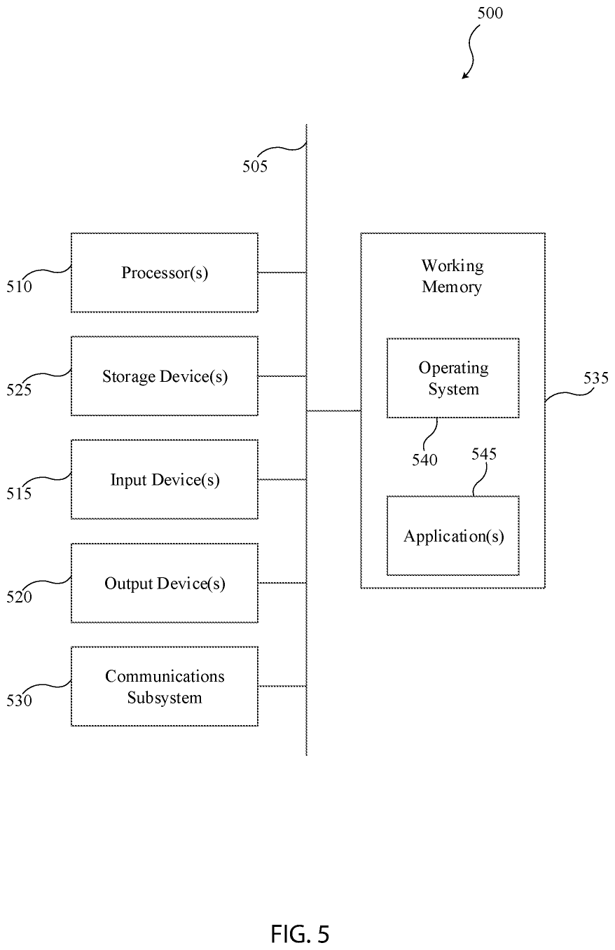

The computational system 500, shown in FIG. 5 can be used to perform any of the embodiments of the invention. For example, computational system 500 can be used to store and/or create the database 605, the dataset descriptors 220, the one or more digital interaction datasets 230, or dataset directory 240, and/or execute processes 300 or process 400. As another example, computational system 500 can perform any calculation, identification and/or determination described here. Computational system 500 includes hardware elements that can be electrically coupled via a bus 505 (or may otherwise be in communication, as appropriate). The hardware elements can include one or more processors 510, including without limitation one or more general-purpose processors and/or one or more special-purpose processors (such as digital signal processing chips, graphics acceleration chips, and/or the like); one or more input devices 515, which can include without limitation a mouse, a keyboard and/or the like; and one or more output devices 520, which can include without limitation a display device, a printer and/or the like.

The computational system 500 may further include (and/or be in communication with) one or more storage devices 525, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 500 might also include a communications subsystem 530, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 530 may permit data to be exchanged with a network (such as the network described below, to name one example), and/or any other devices described in this document. In many embodiments, the computational system 500 will further include a working memory 535, which can include a RAM or ROM device, as described above.

The computational system 500 also can include software elements, shown as being currently located within the working memory 535, including an operating system 540 and/or other code, such as one or more application programs 545, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 525 described above.

In some cases, the storage medium might be incorporated within the computational system 500 or in communication with the computational system 500. In other embodiments, the storage medium might be separate from a computational system 500 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 500 and/or might take the form of source and/or installable code, which, upon compilation and/or installation on the computational system 500 (e.g., using any of a variety of generally available compilers, installation programs, compression/decompression utilities, etc.) then takes the form of executable code.

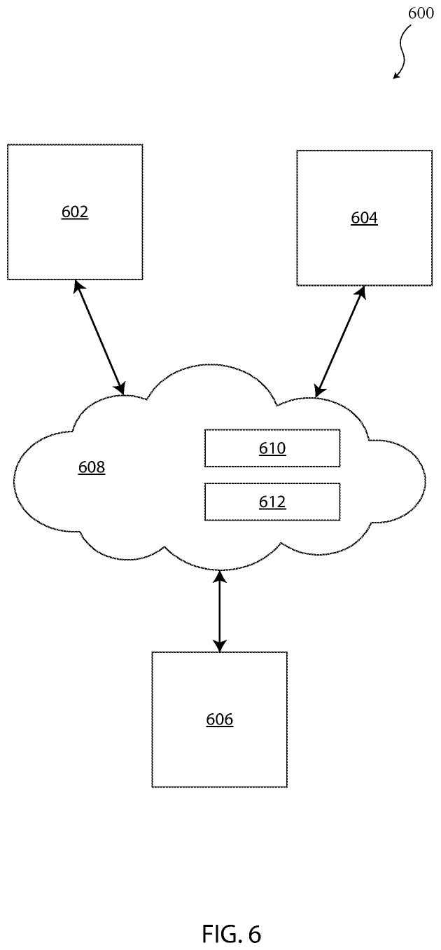

FIG. 6 illustrates an example cloud computing system 600 according to some embodiments. The cloud computing system 600, for example, includes clients 602, 604, and 606 connected to a computing cloud 608. The computing cloud 608, for example, includes processing unit 610 and data storage unit 612, both of which are accessible to clients 602, 604, and 606.

The computing cloud 608, the clients 602, 604, and 606, and/or the data storage unit 612 may include one or more or all of the components of computational system 500.

The computing cloud 608, for example, may be capable of both storing information and performing data functions on information. The computing cloud 608 includes at least one computer that is accessible from a remote location. The computing cloud 608, for example, may include a plurality of storage devices that will be referred to as collectively the storage unit 612, as well as a plurality of processing units that will be referred to collectively as the processing unit 610. The computing cloud 608, for example, may include hardware that is cost prohibitive to deploy and maintain at individual clients 602, 604, and 606. The computing cloud 608, for example, may include software that is cost prohibitive to install, deploy, and maintain at individual computing clouds. The computing cloud 608 may, for example, may provide this hardware and software through secure connections to the clients 602, 604, and 606. While there is one computing cloud 608 shown in FIG. 6, it is explicitly understood that a plurality of clouds may be consistent with this disclosure. It is understood that the disclosed historian system can collect, store, and retrieve data for multiple clients, multiple systems within a single client, as well as multiple systems located within multiple clients.

The clients 602, 604, and 606 may include individual computers, tablets, or mobile devices that are in communication with the computing cloud 608. The clients 602, 604, and 606 are capable of accessing both the processing unit 610 and storage unit 612 that are located in the computing cloud 608. The clients 602, 604, and 606 are able to access both local processes as well as information from the computing cloud 608. The clients 602, 604, and 606 may comprise a plurality of manufacturing tools and sensors to monitor the manufacturing tools. These sensors may detect any operational condition of the manufacturing tools, including, but not limited to, the temperature, vibration, or other measurable operating parameter.

The clients 602, 604, and 606 communicate with the computing cloud 608 through any secured or unsecured method, including Hypertext Transfer Protocol Secure (HTTPS), secure telnet, or file transfer protocol secure (FTPS). Secure methods, for example, may be preferred over unsecure methods, and that the particular method chosen will depend upon the requirements of the function being accessed. This document should not be interpreted as being limited to any particular protocol or method of transferring data. Various other data transfer protocols may be used.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Numerous specific details are set forth to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained in software to be used in programming or configuring a computing device.

Embodiments of the methods disclosed may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

1-23. (canceled)

24. A computing cloud comprising at least one data storage unit comprising at least one memory device configured to store instructions and at least one computer processing unit configure to execute the instructions, wherein the computing cloud is configured to:
provide a web portal for receiving files from a user;
receive a first input file via the web portal, the first input file comprising a first plurality of digital records of interaction between individuals recorded by a first provider;
store the first input file in the data storage;
receive a second input file via the web portal, the second input file comprising a second plurality of digital records of interaction between individuals recorded by a second provider, the second provider being different and distinct from the first provider;
store the second input file in the data storage;
create a digital interaction database from digital records in both the first input file and the second input file, wherein each digital interaction within the digital interaction database comprises at least a date of the digital interaction, a time of the digital interaction, an identifier associated with the sender of the digital interaction, and an identifier associated with the receiver of the digital interaction;
store the digital interaction database in the data storage; and
identify a first individual associated with a first digital record in the first input file that corresponds with a second digital record in the second input file.

25. The computing cloud according to claim 24, wherein each digital interaction within the digital interaction database comprises at least one of the following:
a location of the sender of the digital interaction, a location of the receiver of the digital interaction, a cell tower location associated with a sender of the digital interaction, a cell tower location associated with a receiver of the digital interaction, digital interaction content, photos, text, and a duration of the digital interaction.

26. The computing cloud according to claim 24, wherein the computing cloud is configured to receive a cell phone tower dataset that correlates a cell phone tower location with a cell phone tower identifier and wherein the second input file comprises cell phone tower identifiers associated with at least some of the second plurality of digital records.

27. The computing cloud according to claim 24, wherein the data structure of the first input file is different than the data structure of the second input file.

28. The computing cloud according to claim 24, wherein the first input file is organized differently than the second input file.

29. (canceled)

30. The computing cloud according to claim 24, wherein the first provider or the second provider comprises a cell phone carrier.

31. The computing cloud according to claim 24, wherein the first provider or the second provider comprises a social media company.

32. The method according to claim 24, wherein the first input file or the second input file comprises historical mobile phone records for a specific mobile phone.

33. The computing cloud according to claim 24, wherein the first input file or the second input file comprises historical social media records.

34. The computing cloud according to claim 24, wherein the first input file or the second input file includes a plurality of records, each of the plurality or records including one or more of the following: an interaction date, an interaction time, a sender name, a sender ID, a sender phone number, a sender email address, a sender username, a receiver name, a receiver ID, a receiver phone number, a receiver email address, a receiver username, a GPS location of the sender, a GPS location of the receiver, a tower location of the sender, a tower location of the receiver, a tower identifier of the sender, a tower identifier of the receiver, and interaction content.

35. A computing cloud comprising at least one data storage unit comprising at least one memory device configured to store instructions and at least one computer processing unit configure to execute the instructions, wherein the computing cloud is configured to:
provide a web portal for receiving files from a user;
receive a first digital interaction dataset and a second digital interaction dataset via the web portal, the digital interaction dataset comprising a first plurality of digital records of interaction between individuals recorded by a first provider, the digital interaction dataset comprising a second plurality of digital records of interaction between individuals recorded by a second provider;
select a first digital interaction from a first digital interaction dataset, the first digital interaction dataset comprising a first plurality of digital records of digital interactions between individuals recorded by a first provider, wherein the first digital interaction dataset is associated with a first provider, wherein each digital interaction within the first digital interaction dataset comprises at least a date of the digital interaction, a time of the digital interaction, an identifier associated with the sender of the digital interaction, and an identifier associated with the receiver of the digital interaction;
determine a first digital interaction identifier from the first digital interaction, the first digital interaction identifier comprises either an identifier associated with the sender of the digital interaction or an identifier associated with the receiver of the digital interaction;
search a second digital interaction dataset for a second digital interaction having a second digital interaction identifier that matches the first digital interaction identifier, the second digital interaction dataset is associated with a second provider that is different and distinct from the first provider; and
store a link between the second digital interaction in the second digital interaction dataset with the first digital interaction in the first digital interaction dataset in the data storage unit.

36. The computing cloud according to claim 35, wherein the computing loud is configured to:
select a third digital interaction from the first digital interaction dataset;
determine a third digital interaction identifier from the third digital interaction, the third digital interaction identifier identifies a party associated with the first digital interaction; and
find a fourth digital interaction identifier within the second digital interaction of a second digital interaction dataset that matches the third digital interaction identifier.

37. The computing cloud according to claim 35, wherein the computing loud is configured to:
find a third digital interaction identifier associated with a third digital interaction of a third digital interaction dataset that matches the first digital interaction identifier.

38. The computing cloud according to claim 35, wherein the computing loud is configured to
search a third digital interaction dataset for one or more digital interactions that include a third digital interaction identifier that matches the first digital interaction identifier.

39. The computing cloud according to claim 35, wherein the first digital interaction identifier comprises a phone number.

40. The computing cloud according to claim 35, wherein the first digital interaction identifier comprises an email address.

41. The computing cloud according to claim 35, wherein the first digital interaction identifier comprises a username.

42. The computing cloud according to claim 35, wherein the computing cloud is further configured to link the first digital interaction with the second digital interaction.

43. The computing cloud according to claim 35, wherein the first digital interaction dataset and the second digital interaction dataset are different digital interaction datasets.

44. (canceled)

45. (canceled)

46. (canceled)

47. A method comprising:
receiving a first input file, the first input file comprising a first plurality of digital records of interaction between individuals recorded by a first provider;
receiving a second input file, the second input file comprising a second plurality of digital records of interaction between individuals recorded by a second provider, the second provider being different and distinct from the first provider;
creating a digital interaction database from digital records in both the first input file and the second input file, wherein each digital interaction within the digital interaction database comprises at least a date of the digital interaction, a time of the digital interaction, an identifier associated with the sender of the digital interaction, and an identifier associated with the receiver of the digital interaction; and
identifying a first individual associated with a first digital record in the first input file that corresponds with a second digital record in the second input file.
